(19) United States
(12) Patent Application Publication
(10) Pub. No.: US 2012/0308287 A1
(43) Pub. Date: Dec. 6, 2012

(54) MOVING APPARATUS FOR PRINTER

(75) Inventors: SHU-YA CHIANG, Tu-Cheng (TW); YU-O HU, Tu-Cheng (TW); LI-HUI LIU, Tu-Cheng (TW)

(73) Assignee: HON HAI PRECISION INDUSTRY CO., LTD., Tu-Cheng (TW)

(21) Appl. No.: 13/310,620

(22) Filed: Dec. 2, 2011

(30) Foreign Application Priority Data
May 30, 2011 (TW) 100118928

(51) Int. Cl. B41J 25/34

(52) U.S. Cl. 400/283

(57) ABSTRACT

A moving apparatus for a printer includes a support board, a motor mounted on the support board, an endless belt, and a printing module. A sliding pole is located on the support board. A follower wheel is rotatably mounted on the support board. The motor includes a drive wheel. A belt is set on the drive wheel and the follower wheel. A sliding groove is defined in the printing module. The printing module is located on the support board with the sliding pole located in the sliding groove. The printing module is attached to the belt. The motor is adapted to drive the drive wheel to rotate, and the belt is adapted to bring the printing module to slide on the sliding pole.

### BACKGROUND

1. Technical Field

The present disclosure relates to moving apparatuses, more particularly, to a moving apparatus used in a printer.

2. Description of Related Art

A printer may include a printing module with a print head and a moving module for driving the printing module across the paper to be printed. The print head of the printing module should be capable of fluent and stable movement to assure printing quality. Usually, the printing module slides on a shaft which is mounted on the printer. When the shaft is in use for a long period of time, it may become a loose fit in the printer module, which may cause faltering in the printing module.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded and isometric view of an embodiment of a moving apparatus for a printer.

FIG. 2 is similar to FIG. 1, but viewed from another aspect.

FIG. 3 is an assembly view of the moving apparatus of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

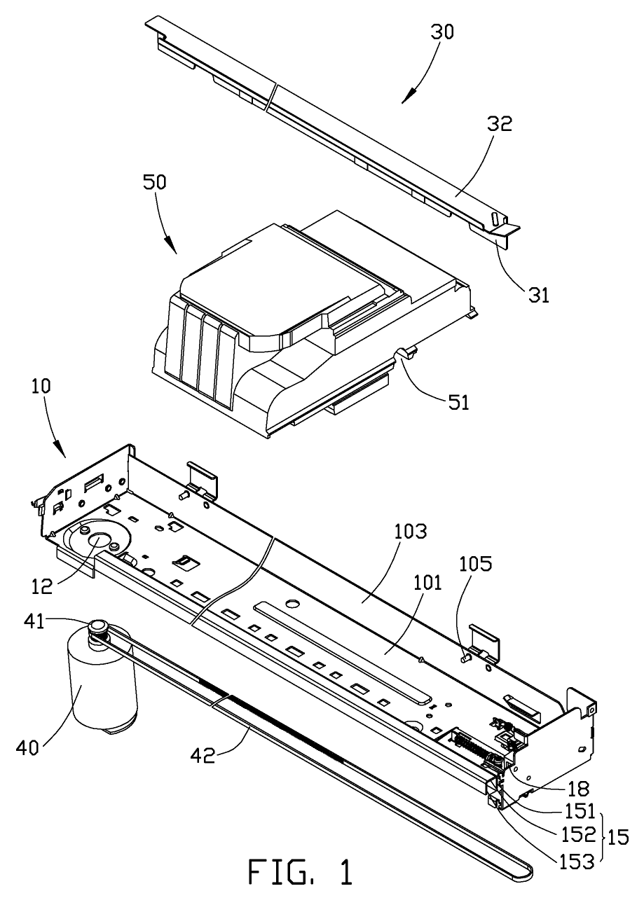

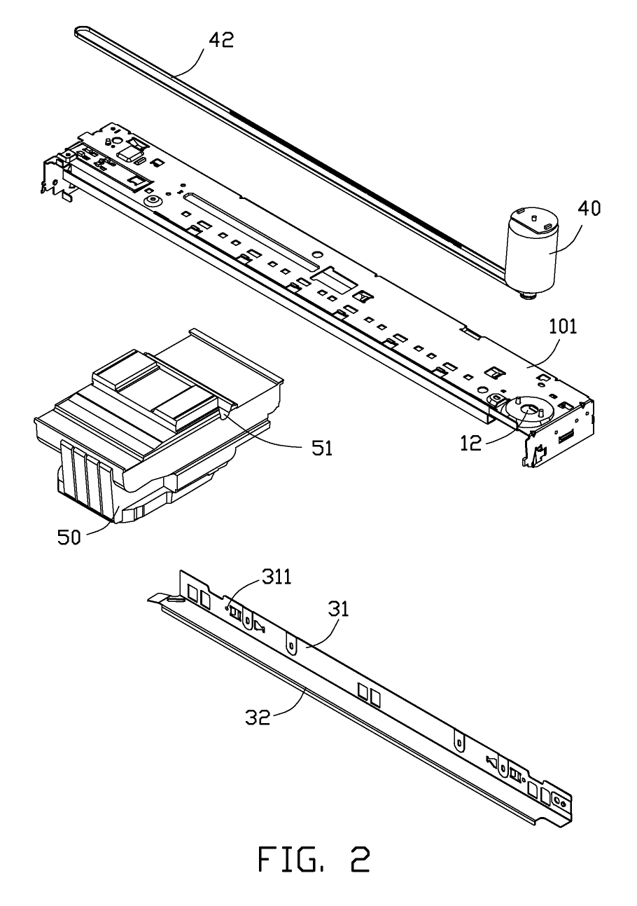

Referring to FIGS. 1 and 2, an apparatus for providing movement to the print head of a printer in accordance with an embodiment includes a support board 10, a restricting piece 30 and a printing module 50. The printing module 50 equipped with the print head (not shown) can slide on the support board 10.

The support board 10 includes a bottom wall 101 and a side wall 103. A first edge of the bottom wall 101 is connected to an “n”-section sliding pole 15. The side wall 103 is perpendicularly connected to a second edge of the bottom wall 101. The second edge is opposite to the first edge. The sliding pole 15 includes a connecting piece 151, a first bent piece 152, and a second bent piece 153. The connecting piece 151 is perpendicularly connected to the first edge of the side wall 103. The first bent piece 152 is perpendicularly connected between the connecting piece 151 and the second bent piece 153. The second bent piece 153 is parallel to the connecting piece 151. The bottom wall 101 defines a through hole 12 adjacent to a first end of the sliding pole 15. A follower wheel 18 is mounted on the bottom wall 101 adjacent to a second end of the sliding pole 15. A plurality of securing pins 105 are mounted on the side wall 103.

The restricting piece 30 includes a upright securing portion 31 and a horizontal restricting portion 32. The securing portion 31 defines a plurality of securing holes 311 corresponding to the plurality of securing pins 105 of the side wall 103.

A motor 40 can be mounted on the bottom wall 101. The motor 40 includes a drive wheel 41. The motor 40 can drive the drive wheel 41 to rotate.

A belt 42 can be set on the drive wheel 41 and the follower wheel 18. The drive wheel 41 rotates to move the belt 42, and the follower wheel 18 is rotated accordingly.

The printing module 50 defines a sliding groove 51 at a bottom portion thereof.

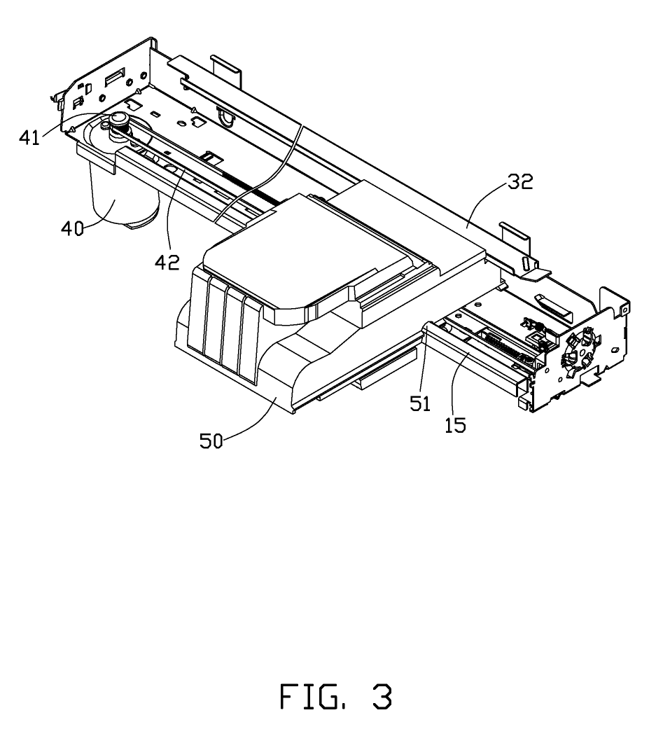

Referring to FIGS. 1 to 3, in assembly, the drive wheel 41 of the motor 40 is inserted in the through hole 12. Then, the motor 40 is secured on the bottom wall 101. The belt 42 is set on the drive wheel 41 and the follower wheel 18 to transmit the rotary motion of the drive wheel 41 into linear motion.

In succession, the plurality of securing pins 105 is inserted in the plurality of securing holes 311 to mount the restricting piece 30 onto the support board 10. The restricting portion 32 of the restricting piece 30 is located above the bottom wall 101. Then, the printing module 50 is placed on the support board 10 with the sliding pole 15 located in the sliding groove 51. The printing module 50 is freely slidable on the sliding pole 15. Simultaneously, the printing module 50 is attached to the belt 42 at one point and may be moved by the belt 42. The restricting portion 32 and the bottom wall 101 restrict between them a portion of the printing module 50.

In use, the motor 40 rotates the drive wheel 41 to move the belt 42 so as to slide the printing module 50 on the sliding pole 15.

In the moving apparatus, the sliding pole 15 is integrally formed on the support board 10 and the sliding pole 15 may not come loose from the support board 10. The greater surface area of the sliding pole 15 (compared to the smaller surface area of a round rod or shaft), the greater precision for the print head and a longer service life.

It is to be understood, however, that even though numerous characteristics and advantages of the embodiments have been set forth in the foregoing description, together with details of the structure and functions of the embodiments, the disclosure is illustrative only, and changes may be made in detail, especially in the matters of shape, size, and arrangement of parts within the principles of the invention to the full extent indicated by the broad general meaning of the terms in which the appended claims are expressed.

What is claimed is:

1. A moving apparatus for a printer, comprising:
a support board, a sliding pole located on the support board, and a follower wheel rotatably mounted on the support board;
a motor mounted on the support board, the motor comprising a drive wheel;
a belt set on the drive wheel and the follower wheel; and
a printing module, a sliding groove defined in the printing module, the printing module located on the support board with the sliding pole located in the sliding groove, and the printing module is attached to the belt and movable together with the belt;
wherein the motor is adapted to drive the drive wheel to rotate, and the belt is adapted to bring the printing module to slide on the sliding pole.

2. The moving apparatus of claim 1, wherein the support board comprises a bottom wall, and a first edge of the bottom wall is connected to the sliding pole.

3. The moving apparatus of claim 2, wherein a side wall is perpendicularly connected to a second edge of the bottom wall, the second edge is opposite to the first edge; and a restricting piece, which restricts a portion of the printing module, is mounted on the side wall.

4. The moving apparatus of claim 3, wherein the restricting piece comprises a securing portion, a plurality of securing holes is defined in the securing portion, a plurality of securing pins is mounted on the side wall, and the plurality of securing pins is mounted in the plurality of securing holes.

5. The moving apparatus of claim 4, wherein the restricting piece further comprises a restricting portion which is perpendicularly connected to the securing portion, the restricting portion is located above the bottom wall, and the restricting portion and the bottom wall restrict the portion of the printing module therebetween.

6. The moving apparatus of claim 2, wherein the sliding pole is “n”-shaped.

7. The moving apparatus of claim 6, wherein the sliding pole comprises a connecting piece, a first bent piece, and a second bent piece, the connecting piece is perpendicularly connected to the first edge of the bottom wall, the first bent piece is perpendicularly connected between the connecting piece and the second bent piece, and the second bent piece is parallel to the connecting piece.

8. The moving apparatus of claim 1, wherein the support board defines a through hole which is adjacent to a first end of the sliding pole, the follower wheel is adjacent to a second end of the sliding pole, and the drive wheel is inserted in the through hole.

9. A moving apparatus for a printer, comprising:
a support board with a sliding pole located thereon, a through hole defined on the support board and adjacent to a first end of the sliding pole, a follower wheel rotatably mounted on the support board and adjacent to a second end of the sliding pole;
a motor mounted on the support board, the motor comprising a drive wheel, the drive wheel inserted through the through hole;
a belt set on the drive wheel and the follower wheel; and
a printing module defining a sliding groove, the printing module located on the support board with the sliding pole located in the sliding groove, the printing module attached to the belt and movable together with the belt;
wherein the motor is adapted to drive the drive wheel to rotate, and the belt is adapted to bring the printing module to slide on the sliding pole between the first end and the second end.

10. The moving apparatus of claim 9, wherein the support board comprises a bottom wall, and a first edge of the bottom wall is connected to the sliding pole.

11. The moving apparatus of claim 10, wherein a side wall is perpendicularly connected to a second edge of the bottom wall, the second edge is opposite to the first edge; and a restricting piece, which restricts a portion of the printing module, is mounted on the side wall.

12. The moving apparatus of claim 11, wherein the restricting piece comprises a securing portion, a plurality of securing holes is defined in the securing portion, a plurality of securing pins is mounted on the side wall, and the plurality of securing pins is mounted in the plurality of securing holes.

13. The moving apparatus of claim 12, wherein the restricting piece further comprises a restricting portion which is perpendicularly connected to the securing portion, the restricting portion is located above the bottom wall, and the restricting portion and the bottom wall restrict the portion of the printing module therebetween.

14. The moving apparatus of claim 10, wherein the sliding pole is “n”-shaped.

15. The moving apparatus of claim 14, wherein the sliding pole comprises a connecting piece, a first bent piece, and a second bent piece, the connecting piece is perpendicularly connected to the first edge of the bottom wall, the first bent piece is perpendicularly connected between the connecting piece and the second bent piece, and the second bent piece is parallel to the connecting piece.
